(19) United States
(12) Patent Application Publication
(10) Pub. No.: US 2014/0049542 A1
(43) Pub. Date: Feb. 20, 2014

(54) Layer Display of Volume Data

(71) Applicant: Klaus Engel, Nurnberg (DE)

(72) Inventor: Klaus Engel, Nurnberg (DE)

(21) Appl. No.: 13/968,041

(22) Filed: Aug. 15, 2013

(30) Foreign Application Priority Data
Aug. 16, 2012 (DE) DE 102012214604.0

(51) Int. Cl. G06T 15/50; G06T 15/83

(52) U.S. Cl. CPC G06T 15/506; G06T 15/83
USPC 345/426

(57) ABSTRACT

A layer display of volume data is provided. A layer orientation for the layer display of the volume data is selected. At least one layer is calculated in accordance with the selected orientation. A virtual light source is selected for the inclusion of light effects in the display of the layers. A calculation is performed of a light effect generated by the virtual light source with the help of a reflection model for the at least one layer. The at least one layer is displayed, taking account of the light effect.

This application claims the benefit of DE 10 2012 214 604.0, filed on Aug. 16, 2012, which is hereby incorporated by reference.

### BACKGROUND

The present embodiments relate to a method and a device for layer display of volume data.

Imaging methods use a series of different technologies, by which information is obtained about the nature of an object. Methods that, for example, make use of ultrasound, X-ray radiation or spin excitations (e.g., nuclear spin tomography) are widespread.

Modern methods may resolve information in three dimensions and supply volume data, including gray-scale values, that is present for points in space. The gray-scale values represent a measure of the density of the examined object at the corresponding point in space. The term voxel is also used in connection with these gray-scale values existing at points in space. The voxels form a three-dimensional array of gray-scale values. To visualize the result of an imaging procedure, voxels defined in three dimensions are mapped to pixels defined in the two dimensions of a screen.

For mapping voxels to pixels in order to display the pixels on a screen, the term ‘volume rendering’ has been adopted. In various medical imaging procedures, the voxels or gray-scale values lie in axial layers or sections. Axial layers are layers orthogonal to a characterized direction (e.g., a z axis). This z axis may correspond in computed tomography to the direction of movement. Inside the axial layers, the resolution may be higher than in the direction of the z axis.

The simplest type of visualization is to display the individual axial layers on a screen. In this case, the individual layers may be displayed one after the other, for example. On an appropriately large screen or monitor, the display of, for example, 2-4 layer images next to one another is a suitable approach.

The multi-planar reformatting or multi-planar reconstruction (MPR) procedure provides an upgraded axial layer-related display. In connection with this procedure, layer displays are calculated with a different orientation. The sagittal and coronal layers orthogonal to the axial sections are commonly displayed in this case. In principle, an MPR procedure may, however, be performed for any orientation of layers. Using interpolation, the gray-scale values inside the layers are calculated and displayed in suitable fashion.

Besides the MPR procedures, there are other, more modern procedures (e.g., ray casting) that simulate the penetration of the volume with optic radiation. Nevertheless, MPR procedures fulfill an important function for visualizing object properties, because the use entails advantages in particular situations. For example, when parts of the object are covered or occluded, a suitably selected section may provide information that is not easily accessible using ray casting.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, layer displays of volume data is improved.

In one embodiment, at least one display of at least one layer of an object is determined (e.g., in the course of an MPR procedure). The at least one layer is calculated according to a predefined orientation. This orientation may correspond to an axial, coronal or sagittal display. A stack of parallel layers with the selected orientation may be calculated. Alternatively, only an individual layer may be calculated in a predefined depth. In one embodiment, a virtual light source is used for the application of a reflection model. In this case, the exposure to light of a fixed shape (e.g., punctiform light source, parallel light beams) from a defined direction (e.g., perpendicular to the at least one plane or, to better display light effects, at a small angle to the plane perpendiculars) is simulated onto the at least one layer. Several light sources (e.g., of a different shape) may also be provided. In an extension, a dynamic exchange takes place between different light sources. The light source may be inclined (e.g., slightly inclined) compared to the direction of view of the observer. A frontal view of the at least one plane may, for example, be assumed in this case as an observer position (e.g., which may influence the use of reflection models). The display of the at least one layer is calculated taking into account at least one light effect produced by the reflection model (e.g., diffuse scattered light and/or specular light).

By taking account of light effects when displaying layers on a screen, information relating to the direction perpendicular to the at least one layer is also taken into account. In other words, information about changes (e.g., lead) in the layer region is taken into account, and not merely a scalar value on the layer. Consequently, valuable additional information is obtained for the analysis using sectional viewing. The visual impression is improved by the three-dimensional display of the layers.

A recording of measured data of an object may be taken in the course of an imaging procedure (e.g., CT, MRt, ultrasound, PET, SPECT), from which the volume data is determined (e.g., using a reconstruction procedure). The examined object may be both a patient and also a workpiece checked in the course of material examination.

The reflection model used may be a local reflection model based on the modification of a pixel calculation. Due to this reflection model, a portion occasioned by diffuse scattered light may be determined using a locally calculated gradient. For this gradient, the weighted sum composed of a normal vector determined for the at least one layer and a gradient determined with the at least one plane from the volume data at an intersection point of a beam generated for pixel calculation may be used. The weighting used enables the layer display to be better adjusted or tuned.

A Phong shading or a related local reflection model (e.g., Blinn-Phong model, Warn model) may, for example, be used as a reflection model. The model may use a surface gradient for the calculation of a light effect, so that the development of the use of a weighted sum composed of layer normal and gradient may be applied instead of the surface gradient.

In one embodiment, a device and a computer program for performing a method for layer display are also provided.

### BRIEF DESCRIPTION OF THE DRAWINGS

FIG. 1 shows one embodiment of a spiral CT device having several rows of detector elements in a schematic diagram in the z direction;

FIG. 2 shows a longitudinal section along the z axis through one embodiment of the device according to FIG. 1;

FIG. 3 shows one embodiment of an MPR method in comparison to a conventional MPR procedure;

FIG. 4 shows a layer calculated using a conventional MPR procedure;

FIG. 5 shows a layer calculated using one embodiment of an MPR method; and

FIGS. 6-9 show an exemplary effect of weighting when forming the sum of MPR surface normals and gradients in the calculated image.

### DETAILED DESCRIPTION OF THE DRAWINGS

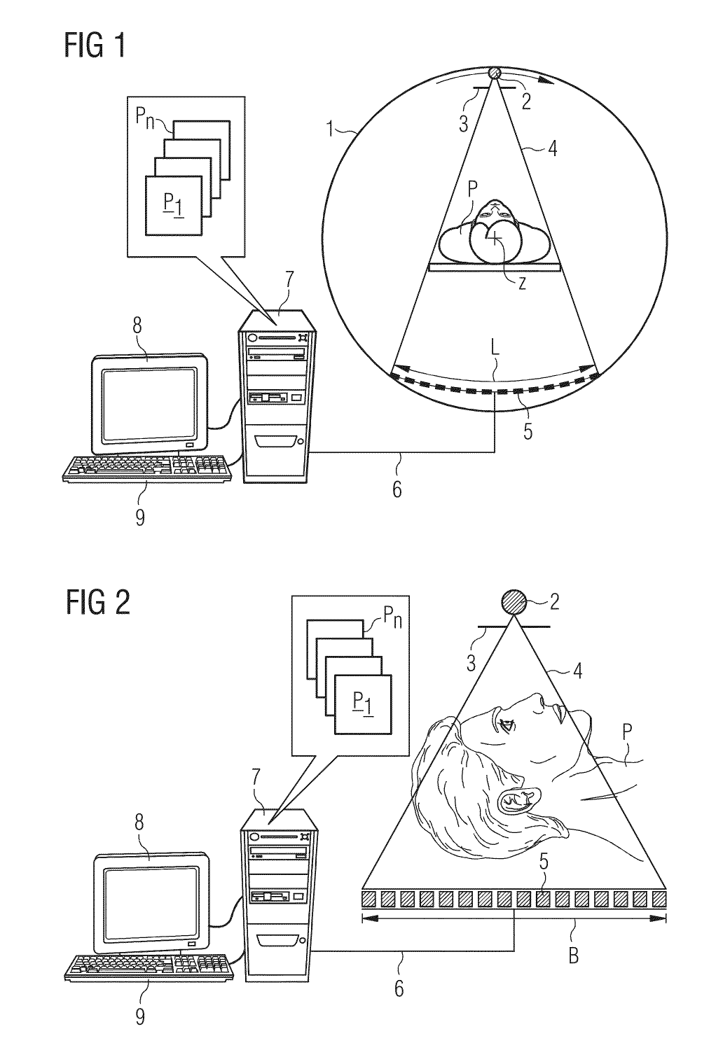

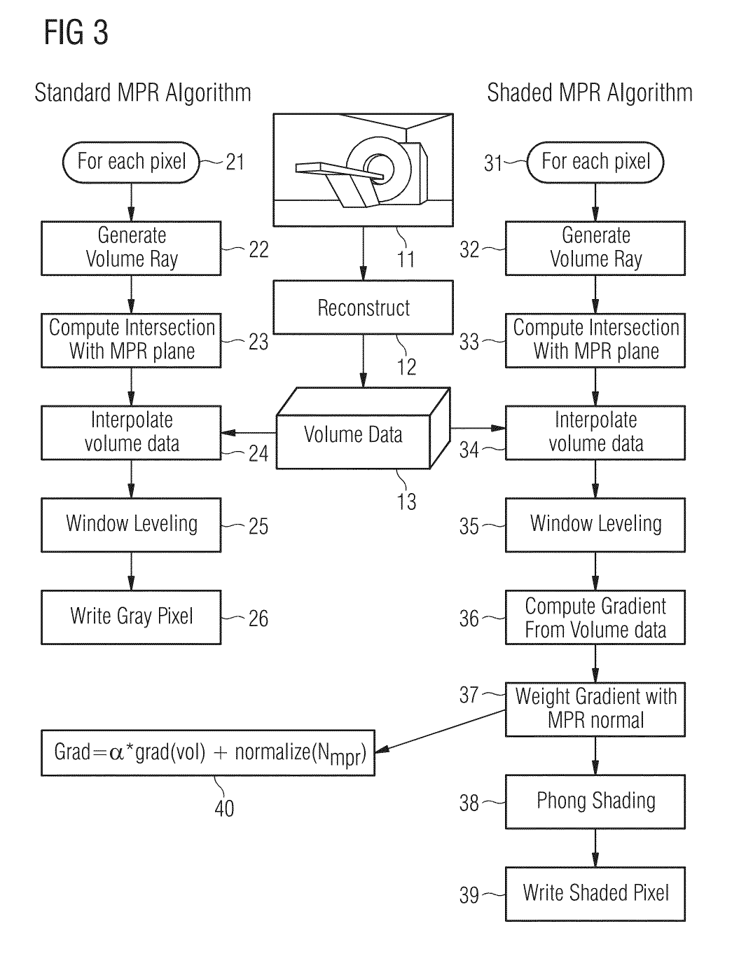

FIGS. 1 and 2 show one embodiment of a spiral CT device with a multi-row detector. FIG. 1 schematically shows a gantry 1 with a focus 2 and a likewise rotating detector 5 (e.g., with width B and length L) in a section perpendicular to the z axis. FIG. 2 shows a longitudinal section in the direction of the z axis. The gantry 1 has an X-ray source with a schematically illustrated focus 2 and a beam diaphragm 3 close to the X-ray source upstream of the focus 2. A ray beam 4, bounded by the beam diaphragm 3, runs from the focus 2 to the opposing detector 5, and penetrates a patient P lying therebetween. Scanning is performed during the rotation of the focus 2 and the detector 5 around the z axis. The patient P is, at the same time, moved in the direction of the z axis. In the coordinates system of the patient P, this results in a spiral path S for the focus 2 and the detector 5 with a gradient or feed V, as shown spatially and schematically in FIG. 3.

While the patient P is being scanned, the dose-dependent signals captured by the detector 5 are transmitted to a computing unit 7 via a data/control line 6. With the help of known methods that are laid down in program modules P₁ to Pₙ shown, a spatial structure of the scanned region of the patient P is calculated or reconstructed from the measured raw data with respect to absorption values in a known manner (e.g., FBP procedure, Feldkamp algorithm, iterative procedure). The calculated absorption values are present in the form of voxels. In medical imaging, these voxels are gray-scale values.

The remaining operation and control of the CT device is likewise effected by the computing unit 7 and the keyboard 9. The calculated data may be output via the monitor 8 or a printer (not shown). For the display on the monitor 8 or to generate images for archiving (e.g., PACS), an image is generated from the gray-scale values. This equates to a mapping of the voxels to pixels, from which the image is composed. Corresponding procedures are referred to as volume rendering. A frequently used procedure for volume rendering is ray casting or calculation of pixels by simulated beams. However, according to one or more of the present embodiments, a layer display is used (e.g., an MPR procedure that is explained in FIG. 3).

FIG. 3 shows one embodiment of a procedure in comparison to a conventional MPR procedure. The starting point is volume data 13 that was obtained using an imaging procedure. Data for an object to be examined may be recorded using a modality 11, and the volume data 13 is obtained therefrom in a reconstruction act 12.

The modality 11 may, for example, use X-ray technology, nuclear spin tomography, ultrasound, position emission tomography (PET) or single-photon emission computed tomography (SPECT). In the modalities shown in FIGS. 1 and 2, projections of the object may be recorded from different directions, from which the volume data is reconstructed using an iterative (e.g., Feldkamp algorithm) or exact reconstruction procedure (e.g., FBP, filtered back-projection).

The volume data is conventionally displayed, as on the left side of FIG. 3, and visualized using an MPR procedure of one or more of the present embodiments, as shown on the right side. The procedure for a layer or a section is shown below. A layer is defined, for example, as a section of the volume data with a plane. The plane may, for example, be defined by a point and two vectors not parallel to one another. In one embodiment, the layer is predefined and input by selecting an orientation and a depth or a distance from the observer. An input may be effected by an input panel. A corresponding procedure may be used for a plurality of parallel layers, so that an image stack (e.g., plurality) of sections for a selected orientation of the sections is obtained. The layer distance may also be an input parameter.

The method acts discussed below may essentially be identical for conventional methods and the method of one or more of the present embodiments. Differences are described subsequently.

A value calculation is started for each pixel of a display on a screen (acts 21,31). A beam associated with the pixel (acts 22,32) is propagated from a predefined direction (e.g., the direction of view) through the volume, and a point of intersection with a plane to be displayed is determined (acts 23,33). By interpolating volume data 13 or voxels, a gray-scale value (or a value of the reconstructed data) is determined at this point of intersection (acts 24,34).

In medical applications, a scale, which is named after the scientist Hounsfield and ranges approximately from −1000 (e.g., for lung tissue) to 3000 (e.g., bones) is used to describe the reconstructed attenuation values. Each value on this scale is assigned a gray-scale value, so that overall there are about 4000 gray-scale values to be displayed. This schema, which in CT is normal in three-dimensional image reconstructions, may not easily be transferred to monitors used for visualization. This is because on a standard 8-bit monitor, a maximum of 256 (i.e., 2⁸) gray-scales may be displayed. A greater number of gray-scales may not be displayed because the granularity of the display already significantly exceeds that of the human eye, which may distinguish approximately 35 gray-scales. To display human tissue, an attempt is hence made to extract the diagnostically interesting details. For this purpose, a window that includes a determined gray-scale range defined around a level relevant for the diagnosis is fixed. This is also referred to as window leveling (acts 25,26).

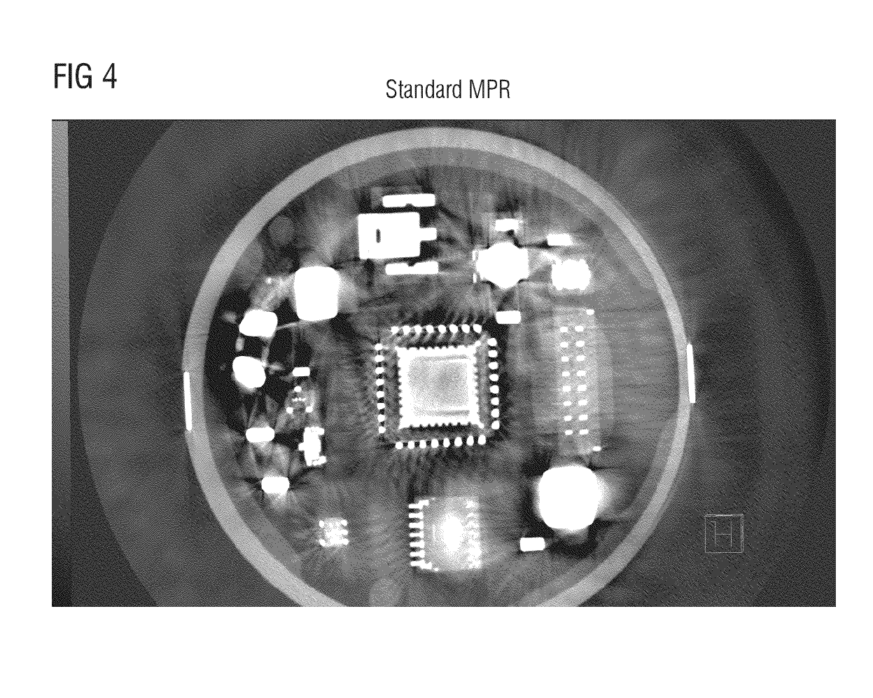

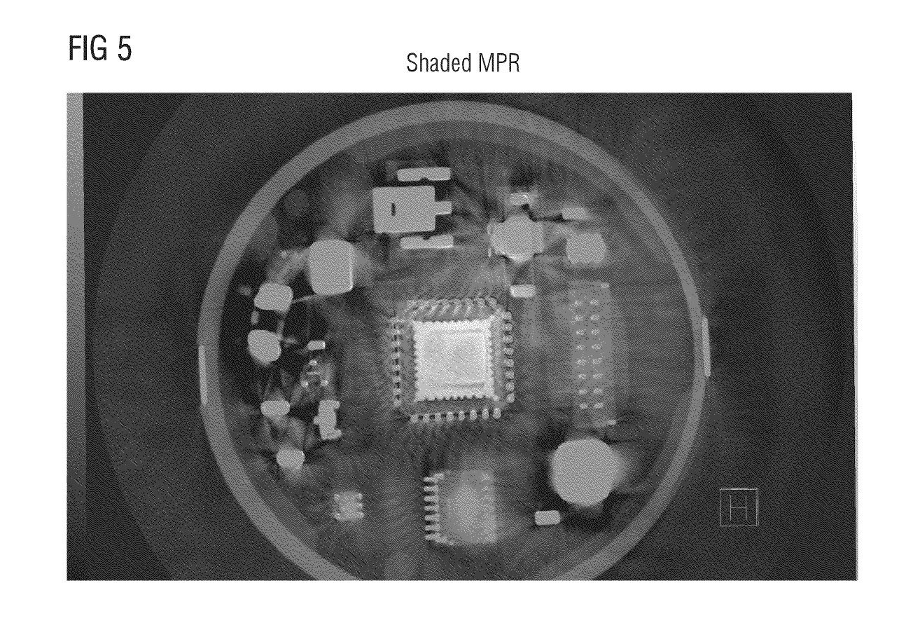

Conventionally, the gray-scale value obtained in the course of window leveling is used as a pixel for display on a screen. An image generated using this conventional method is shown in FIG. 4.

One or more of the present embodiments improve this image display by taking account of light effects in the course of a reflection model. A local reflection model or light model may, for example, be used. Local reflection models may define, at a point on the surface, components consisting of ambient light, diffuse scattered light and specular light. In other words,

I=I_{ambient}+I_{diffuse}+I_{specular.} (1)

The ambient light represents a basic level of diffuse light present as a result of scattering on all objects in the space. The diffuse light is not assigned to a specific light source and thus not to a direction. The diffuse portion relates to the light source, the irradiating intensity of which is weighted with a material constant k_{d}. The directions of the light source L and of the normals N are included in this term. The specular light is, apart from the material constant kₛ, still dependent on the standpoint of the observer. The terms of the equation (1) are expressed as follows in the course of the Phong reflection model:

I=Iₐkₐ+I_{d}{k_{d}(L•N)+kₛ(R•V)ⁿ} (2)

I_{d} is the irradiated intensity, R the reflection vector, V is a vector to the position of the observer, n is an exponent that may be fixed in accordance with the desired rawness, and “•” is the scalar product.

In connection with the exemplary embodiment, Phong shading (e.g., normal vector interpolation shading) is used. Shade and light effects are created by this shading based on a local reflection model. The Phong shading uses an interpolation of the surface normal as standard. The light intensity is calculated from the Phong reflection model with the help of the normals. A portion of a perfect reflection dependent on the direction of view of the observer (or the direction of the beam generated in act 23) and a portion of a diffuse reflection according to Lambert's law may be taken into account. The portions of the light intensity are determined from the angular position of light source and observer standpoint to the normal and are then adjusted to the desired surface impression (e.g., matt or specular).

For the shading, there are various possibilities for the virtual light source influencing the shading. The positions of observer and light source may be allowed to coincide (e.g., in rendering, the term also used in this connection is ‘headlight’). However, one or more possibly punctiform light sources that do not coincide with the position of the observer may also be provided. It may further be provided that a light incidence in a defined direction is used in the course of the shading calculation. Colored light sources may also be deployed. An RGB value for a color display may thus be determined directly in the course of the shading instead of a corrected gray-scale value.

The gradient of the volume data at the interface of the beam 32 and the MPR plane is calculated in act 36 for the use of the Phong model. This is done, for example, using a differential procedure or the interpolation of leads numerically calculated for voxels. This volume normal is not directly deployed for the use of the Phong model. Instead, the gradient of the MPR plane calculated in act 37 is mixed with the gradient of the volume data. The mixture ratio is determined by the weighting factor a (formula 40 in FIG. 3). In other words,

Grad=α·grad(vol)+normalize(Nₘₚᵣ) (3)

“Grad” is the gradient vector used in the mathematical formulation of the shading. This is composed of the gradient (e.g., weighted with a weighting factor α) of the volume data at the location relevant to the pixel calculation and a standardized vector Nₘₚᵣ that is perpendicular to the MPR plane.

In act 38, the Phong shading is performed, and the pixel adjusted using shading is used for the display on a screen (act 39). This produces a layer display (FIG. 5) that is significantly more three-dimensional than images in conventional procedures.

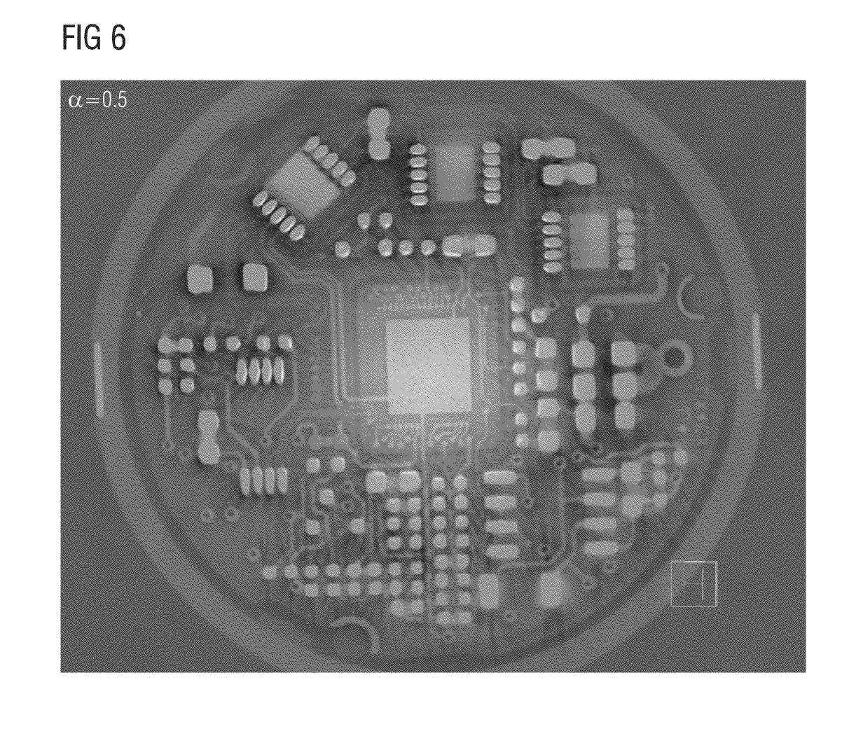

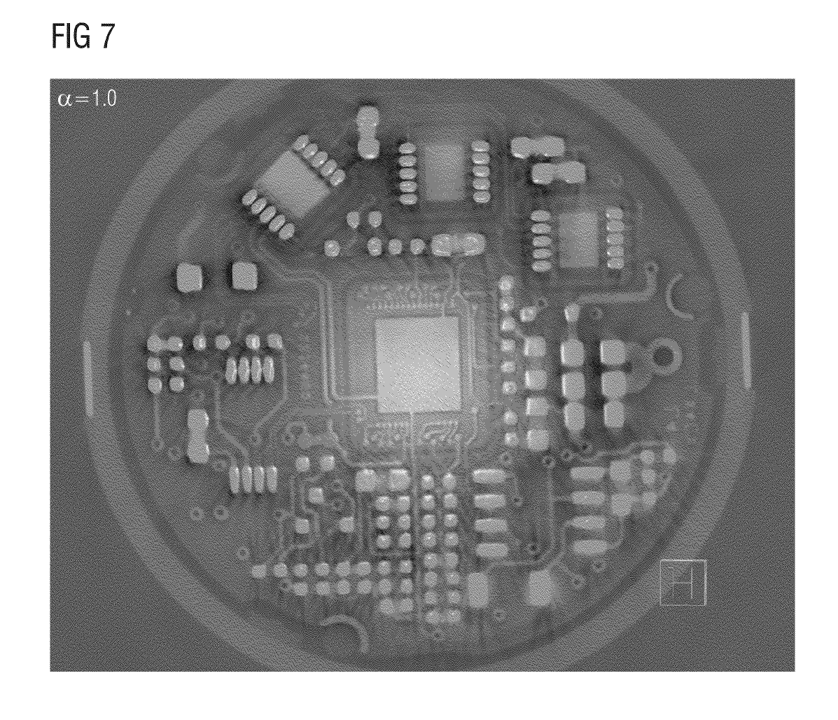

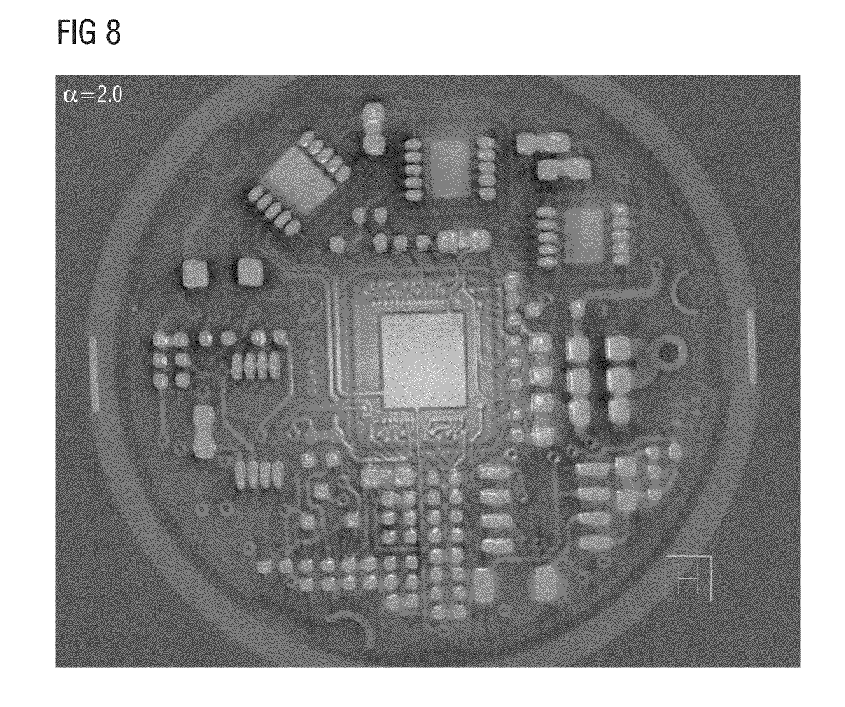

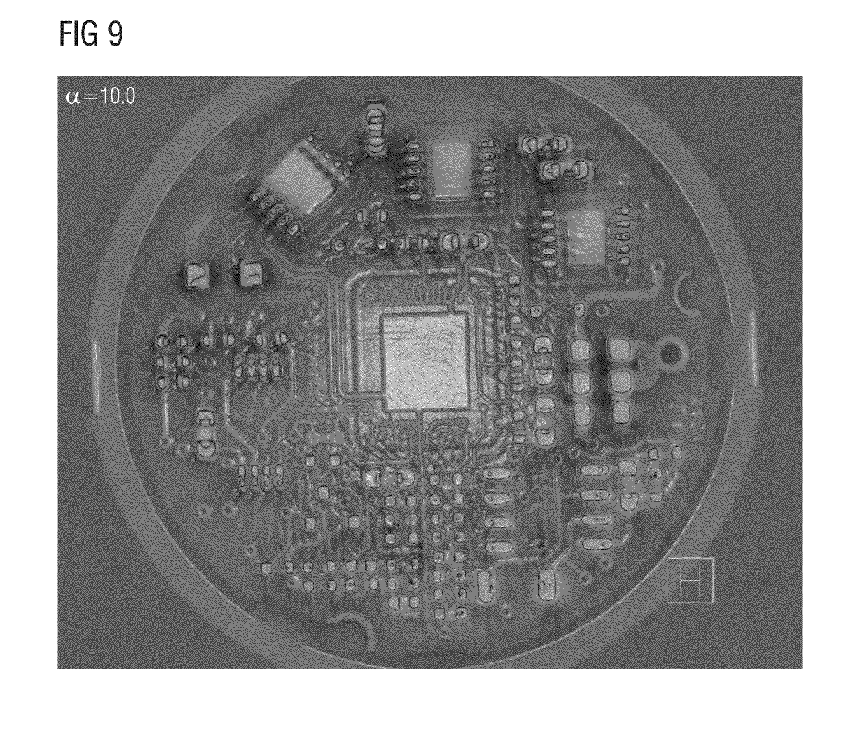

The influence of the weighting factor α is shown in FIGS. 6 to 9. As α increases, the spatial display or the rawness of the displayed image improves. By tuning α, the observer may, as required, generate images that differ to a greater or lesser extent from conventional MPR images.

The invention is not restricted to the subject matter of the exemplary embodiments. For example, the invention may be applied to any volume rendering with layer display. Corresponding volume data may be obtained by a variety of modalities both for medical examinations and for material examinations.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for layer display of volume data, the method comprising:
selecting a layer orientation for a layer display of volume data;
calculating at least one layer in accordance with the selected layer orientation;
selecting a virtual light source for inclusion of light effects when displaying layers;
calculating a light effect generated by the virtual light source with the help of a reflection model for the at least one layer; and
displaying the at least one layer, taking account of the light effect.

2. The method as claimed in claim 1, further comprising:
recording measured data in connection with an imaging method; and
determining the volume data from the recorded measured data.

3. The method as claimed in claim 1, wherein the layer display is effected in connection with a multi-planar reconstruction (MPR) procedure.

4. The method as claimed in claim 1, wherein the reflection model is a local reflection model based on modification of a pixel calculation, and
wherein the method further comprises:
determining, using a locally calculated gradient, a portion occasioned by diffuse scattered light due to the reflection model; and
using, for the locally calculated gradient, a weighted sum from a normal vector determined for the at least one layer and a gradient determined with at least one plane from the volume data at an intersection point of a beam generated for pixel calculation.

5. The method as claimed in claim 1, wherein Phong shading or a local reflection model is used as the reflection model.

6. The method as claimed in claim 2, wherein the layer display is effected in connection with a multi-planar reconstruction (MPR) procedure.

7. The method as claimed in claim 2, wherein the reflection model is a local reflection model based on modification of a pixel calculation, and
wherein the method further comprises:
determining, using a locally calculated gradient, a portion occasioned by diffuse scattered light due to the reflection model; and
using, for the locally calculated gradient, a weighted sum from a normal vector determined for the at least one layer and a gradient determined with at least one plane from the volume data at an intersection point of a beam generated for pixel calculation.

8. The method as claimed in claim 3, wherein the reflection model is a local reflection model based on modification of a pixel calculation, and
wherein the method further comprises:
determining, using a locally calculated gradient, a portion occasioned by diffuse scattered light due to the reflection model; and
using, for the locally calculated gradient, a weighted sum from a normal vector determined for the at least one layer and a gradient determined with at least one plane from the volume data at an intersection point of a beam generated for pixel calculation.

9. The method as claimed in claim 2, wherein Phong shading or a related local reflection model is used as the reflection model.

10. The method as claimed in claim 3, wherein Phong shading or a related local reflection model is used as the reflection model.

11. The method as claimed in claim 4, wherein Phong shading or a related local reflection model is used as the reflection model.

12. A device for layer display of volume data, the device comprising:
an input interface for selecting an orientation of layers for a layer display of volume data;
a computing element configured to:
calculate layers in accordance with the selected orientation; and
calculate a light effect generated by a virtual light source with a reflection model for at least one of the layers, the virtual light source being automatically or manually selectable for inclusion of light effects when displaying the layers; and
a screen configured to display the at least one layer, taking account of the light effect.

13. In a non-transitory computer-readable storage medium that stores instructions executable by a computer for layer display of volume data, the instructions comprising:
selecting a layer orientation for a layer display of volume data;
calculating at least one layer in accordance with the selected layer orientation;
determining a virtual light source for inclusion of light effects when displaying layers;
calculating a light effect generated by the virtual light source with the help of a reflection model for the at least one layer; and
displaying the at least one layer, taking account of the light effect.

14. The non-transitory computer-readable storage medium as claimed in claim 13, wherein the instructions further comprise:
recording measured data in connection with an imaging method; and
determining the volume data from the recorded measured data.

15. The non-transitory computer-readable storage medium as claimed in claim 13, wherein the layer display is effected in connection with a multi-planar reconstruction (MPR) procedure.

16. The non-transitory computer-readable storage medium as claimed in claim 13, wherein the reflection model is a local reflection model based on modification of a pixel calculation, and
wherein the instructions further comprise:
determining, using a locally calculated gradient, a portion occasioned by diffuse scattered light due to the reflection model; and
using, for the locally calculated gradient, a weighted sum from a normal vector determined for the at least one layer and a gradient determined with at least one plane from the volume data at an intersection point of a beam generated for pixel calculation.

17. The non-transitory computer-readable storage medium as claimed in claim 13, wherein Phong shading or a local reflection model is used as the reflection model.

18. The non-transitory computer-readable storage medium as claimed in claim 14, wherein the layer display is effected in connection with a multi-planar reconstruction (MPR) procedure.

19. The non-transitory computer-readable storage medium as claimed in claim 14, wherein the reflection model is a local reflection model based on modification of a pixel calculation, and
wherein the instructions further comprise:
determining, using a locally calculated gradient, a portion occasioned by diffuse scattered light due to the reflection model; and
using, for the locally calculated gradient, a weighted sum from a normal vector determined for the at least one layer and a gradient determined with at least one plane from the volume data at an intersection point of a beam generated for pixel calculation.

20. The non-transitory computer-readable storage medium as claimed in claim 14, wherein Phong shading or a local reflection model is used as the reflection model.
